(19) United States
(12) Patent Application Publication
(10) Pub. No.: US 2009/0219955 A1
(43) Pub. Date: Sep. 3, 2009

(54) LASER OSCILLATION METHOD, LASER, LASER PROCESSING METHOD AND LASER MEASUREMENT METHOD

(75) Inventor: Motoki Kakui, Yokohama-shi (JP)

Correspondence Address: VENABLE LLP, P.O. BOX 34385, WASHINGTON, DC, 20043-9998, US

(73) Assignee: SUMITOMO ELECTRIC INDUSTRIES, LTD., Osaka-shi (JP)

(21) Appl. No.: 12/392,589

(22) Filed: Feb. 25, 2009

(30) Foreign Application Priority Data
Feb. 29, 2008 (JP) P2008-050401

(51) Int. Cl. H01S 3/11

(52) U.S. Cl. 372/10

(57) ABSTRACT

The present invention relates to a laser oscillation method for effectively suppressing fluctuations in pulse widths. The laser oscillation method oscillates a pulsed beam in a laser that comprises pumping means, a resonator, Q-switching means and a controller. The pumping means continuously supplies pumping light to a gain medium, which is arranged on the resonating optical path of the resonator and generates emission light by being supplied with pumping energy. The Q-switching means modulates the resonator losses of the resonator. The controller controls an extinction ratio of Q-switching means to a value that has been selected in accordance with the frequency of repeat use in the pulsed beam such that fluctuations in the full width at half maximum of a pulsed beam outputted from the laser are within a prescribed range of the region of frequency of repeat use used by the Q-switching means.

### BACKGROUND OF THE INVENTION

1. Field of the Invention

The present invention relates to a laser comprising Q-switching means, a laser oscillation method, and a laser processing method and a laser measurement method that utilize the laser.

2. Related Background Art

A pulsed oscillation laser comprises a resonator, in which a laser medium for generating emission light by being supplied with pumping energy is arranged on the resonating optical path, Q-switching means for modulating resonator losses of the resonator, and pumping means for continuously supplying pumping energy to the laser medium.

In the laser, when resonator losses of the resonator are set to a high value by Q-switching means, the population inversion of the laser medium is heightened by the supply of pumping energy from pumping means, and when resonator losses of the resonator are set to a low value thereafter by Q-switching means, a stimulated emission is generated in a short period of time in the laser medium, which is arranged on the resonating optical path of the resonator. Such a stimulated emission light is outputted outside of the resonator as a laser beam.

Since a laser like this is capable of outputting a pulsed beam having high peak power, the laser is utilized in a large number of fields, such as laser processing, optical measurement, optical communications and so forth.

For a laser that uses Q-switching means, for example, control is carried out using a Q-switched laser controller like that described in Japanese Patent Laid-open No. 2002-359422 (Document 1).

### SUMMARY OF THE INVENTION

The present inventors have examined the above prior art, and as a result, have discovered the following problems. That is, since laser light sources using Q-switching means are employed in numerous fields as mentioned above, the pulse energy of the pulsed beam outputted from the laser must be optimized in accordance with various needs. The optimization of the pulse energy is generally carried out by adjusting the repetition frequency used when outputting the pulsed beam.

However, as disclosed in Document 1, it has been ascertained that the pulse width of the respective pulses of the pulsed beam tend to widen when frequency of repeat use is high. When the pulse width widens, this can increase the size of the heat-affected area of the object being processed, which in turn can damage the object being processed. Further, when the laser is used in the fields of optical measurement and optical communications, fluctuations in the pulse width affect temporal resolution, thereby requiring that pulse width fluctuation be held within a fixed range.

The present invention has been developed to eliminate the problems described above. It is an object of the present invention to provide a laser in which pulse width fluctuation is suppressed, a laser oscillation method, and a laser processing method and laser measurement method that make use of the laser.

To achieve this object, a laser oscillation method according to the present invention is for oscillating a pulsed beam using a laser that comprises pumping means, a resonator, Q-switching means and a controller, wherein pumping light is continuously supplied by pumping means to a gain medium, which is arranged on the resonating optical path of the resonator and generates emission light by being supplied with pumping energy, resonator losses of the resonator are modulated by Q-switching means, and the extinction ratio of Q-switching means is controlled by the controller to a value that has been selected in accordance with a repetition frequency such that full width at half maximum fluctuation of the respective pulses of the pulsed beam outputted from the laser are within a prescribed range of the repetition frequency region used by Q-switching means.

The inventors discovered that the extinction ratio of Q-switching means affects fluctuations of the full width at half maximum of the pulsed beam. Therefore, as in the laser oscillation method described above, in accordance with the controller controlling the extinction ratio of Q-switching means to a value that has been selected in accordance with a repetition frequency, fluctuations of the full width at half maximum of the respective pulses of the pulsed beam outputted from the laser can be kept within a prescribed range of the repetition frequency region used by Q-switching means, suppressing pulse width fluctuations of the respective pulses of the pulsed beam.

In a laser oscillation method according to the present invention, it is preferable that the controller set open time of Q-switching means to between three and seven times circulation time during which the emission light to be emitted by the gain medium circulates in the resonator. It is more preferable that open time of Q-switching means be set to between three and four times circulation time during which the emission light to be emitted by the gain medium circulates in the resonator. Open time of Q-switching means may be set to between four and seven times circulation time during which the emission light to be emitted by the gain medium circulates in the resonator.

When the extinction ratio is controlled such that fluctuations of the full width at half maximum of the respective pulses of the pulsed beam fall within a prescribed range, this by contrast can generate a drop in the pulse peak value. Setting the open time of Q-switching means within the above-mentioned range relative to the circulation time during which the emission light circulates in the resonator makes it possible to suppress fluctuations of the full width at half maximum, and in turn, the pulse width of the respective pulses of the pulsed beam outputted from the laser, and at the same time, output a pulsed beam for which the drop in the pulse peak value has been suppressed.

The laser oscillation method according to the present invention can adopt a mode in which the controller controls Q-switching means such that a region of frequency of repeat use comprises the range from 10 to 100 kHz, and the full width at half maximum of the pulsed beam within this range is within ±10% when the region of frequency of repeat use of 20 kHz is used as a reference.

Further, the laser oscillation method according to the present invention can also adopt a mode in which the controller controls Q-switching means such that the region of frequency of repeat use comprises the range from 20 to 250 kHz, and the full width at half maximum of the respective pulses of the pulsed beam within this range is within ±20% when the region of frequency of repeat use of 20 kHz is used as a reference.

A laser according to the present invention is for oscillating a laser beam, and comprises a resonator, in which a gain medium is arranged on the resonating optical path of the resonator and generates emission light by being supplied with pumping energy, pumping means for continuously supplying pumping energy to the gain medium, Q-switching means for modulating resonator losses of the resonator, and a controller for controlling the extinction ratio of Q-switching means to a value that has been selected in accordance with a repetition frequency such that full width at half maximum fluctuations of the respective pulses of a pulsed beam outputted from the laser fall within a prescribed range in the repetition frequency region used by Q-switching means.

In accordance with the above-described laser, in accordance with comprising a controller for controlling the extinction ratio of Q-switching means to a value that has been selected in accordance with a repetition frequency, the full width at half maximum fluctuations of the respective pulses of the pulsed beam outputted from the laser can be set within a prescribed range of the repetition frequency region used by Q-switching means, thereby suppressing fluctuations in the pulse width of the pulsed beam.

Further, it is preferable that the controller of the laser set open time of Q-switching means to between three and seven times circulation time during which the emission light to be emitted by the gain medium circulates in the resonator. Further, it is more preferable that the controller of the laser set open time of Q-switching means to between three and four times circulation time during which the emission light to be emitted by the gain medium circulates in the resonator. Furthermore, in the laser according to the present invention, it is preferable to use a mode in which the region of frequency of repeat use comprises the range from 10 to 100 kHz.

When the extinction ratio is controlled such that full width at half maximum fluctuations of the respective pulses of the pulsed beam fall within a prescribed range, by contrast a drop in the pulse peak value can be generated. Setting the open time of Q-switching means within the above-mentioned range relative to the circulation time during which the emission light circulates in the resonator makes it possible to suppress fluctuations of the full width at half maximum, and in turn, the pulse width of the respective pulses of the pulsed beam outputted from the laser, and at the same time, output a pulsed beam for which the drop in the pulse peak value has been suppressed. Further, setting the region of frequency of repeat use to the above-mentioned range provides a more versatile laser.

A laser processing method according to the present invention is for processing an object to be processed by irradiating a pulsed beam oscillated from the above-described laser onto the object to be processed.

When the above-described laser is used, a pulsed beam in which fluctuations in the pulse width have been suppressed is irradiated onto the object to be processed. Therefore, it is possible to lessen the affects of heat buildup in the object to be processed resulting from the widening of the pulse width of the pulsed beam.

Further, controlling the rate of movement of the object to be processed relative to the irradiation location of the pulsed beam oscillated from the laser enables the adoption of a mode for uniformly controlling the percentage of overlap of beam spots where a pulsed beam oscillated from the laser is irradiated at each pulse.

When pulsed beams are irradiated a number of times on the same spot of the object being processed, the affects of heat buildup in this irradiation location can be great. Therefore, controlling the rate of movement of the object to be processed and maintaining a predetermined percentage of beam spot, overlap can reduce the affects of heat buildup.

Furthermore, the laser processing method according to the present invention is for processing an object to be processed by irradiating a pulsed beam oscillated from the above-described laser onto the object to be processed, and can be set to a mode for optimizing the pulse peak of the pulsed beam by controlling the open time of Q-switching means in accordance with the controller.

In a laser in which fall width at half maximum fluctuations of the respective pulses of the pulsed beam outputted are suppressed by optimizing the extinction ratio, more efficient laser processing can be carried out by controlling the pulse peak value of the pulsed beam in accordance with controlling Q-switching means open time.

Further, a laser measurement method according to the present invention is for measuring a physical quantity of an object to be measured by irradiating a pulsed beam oscillated from the above-described laser onto this object to be measured, and measuring the reflected light that is reflected by the surface of this object to be measured.

In optical measurement, fluctuations in pulse width lead to the deterioration of temporal resolution, thereby raising the likelihood of reduced measurement accuracy. Therefore, as mentioned above, high precision optical measurement is performed by carrying out optical measurement using a pulsed beam for which fluctuations in pulse width have been suppressed by optimizing the extinction ratio.

### BRIEF DESCRIPTION OF THE DRAWINGS

FIG. 1 is a diagram showing the configuration of a laser 1 of a first embodiment according to the present invention;

FIG. 2 is a diagram showing an example of the relationship between the extinction ratio and the voltage applied to an optical switch 13 of the laser 1 according to the first embodiment;

FIG. 3 is a diagram showing ideal extinction ratios corresponding to repetition frequencies when using the laser 1 with the specific configuration example of the first embodiment;

FIG. 4 shows pulse waveforms of pulsed beams outputted from the laser 1 when the optical switch open time is set at 300 ns and the extinction ratio is fixed at 27.63 dB;

FIG. 5 shows pulse waveforms of pulsed beams outputted from the laser 1 in which the optical switch open time is set at 300 ns and the extinction ratio for each repetition frequency is selected on the basis of the relationship of FIG. 3;

FIG. 6 shows pulse waveforms of pulsed beams outputted from the laser 1 when the optical switch open time is set at 220 ns and the extinction ratio for each repetition frequency is selected on the basis of the relationship of FIG. 3;

FIG. 7 shows pulse waveforms of pulsed beams outputted from the laser 1 when the optical switch open time is set at 160 ns and the extinction ratio for each repetition frequency is selected on the basis of the relationship of FIG. 3;

FIG. 8 is a diagram in which the pulse waveforms of FIG. 4 have been normalized;

FIG. 9 is a diagram in which the pulse waveforms of FIG. 5 have been normalized;

FIG. 10 is a diagram in which the pulse waveforms of FIG. 6 have been normalized;

FIG. 11 is a diagram in which the pulse waveforms of FIG. 7 have been normalized;

FIG. 12 is a diagram showing the configuration of a laser 2 of a second embodiment according to the present invention;

FIG. 13 is a diagram showing an example of the relationship between the extinction ratio and the voltage applied to an optical switch 33 of the laser 2 according to the second embodiment;

FIG. 14 is shows pulse waveforms of pulsed beams outputted from the laser 2 when the optical switch open time is set at 160 ns and the extinction ratio for each repetition frequency is selected on the basis of the relationship of FIG. 13;

FIG. 15 is a diagram showing the relationship between repetition frequencies and pulse peak values for the pulse waveforms shown in FIG. 14; and

FIG. 16 is a diagram in which the pulse waveforms of FIG. 14 have been normalized.

### DESCRIPTION OF THE PREFERRED EMBODIMENTS

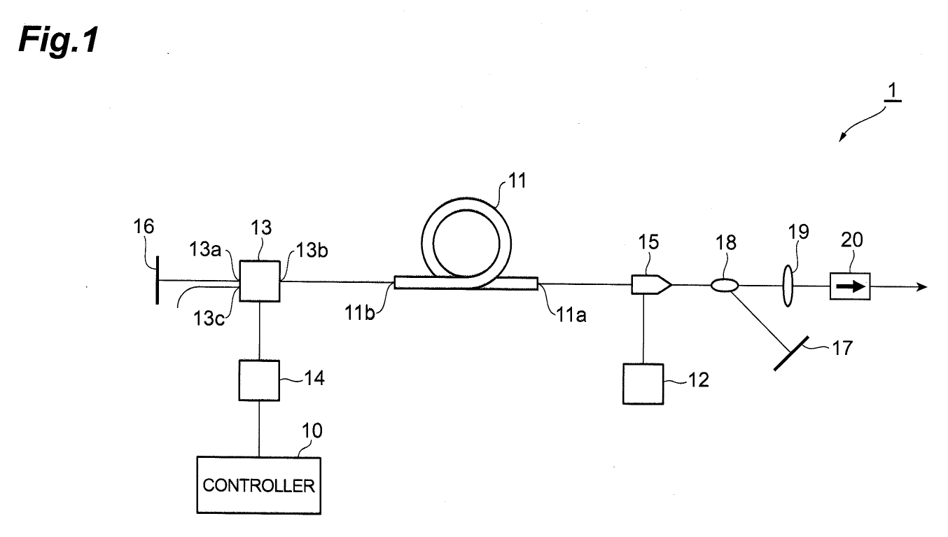

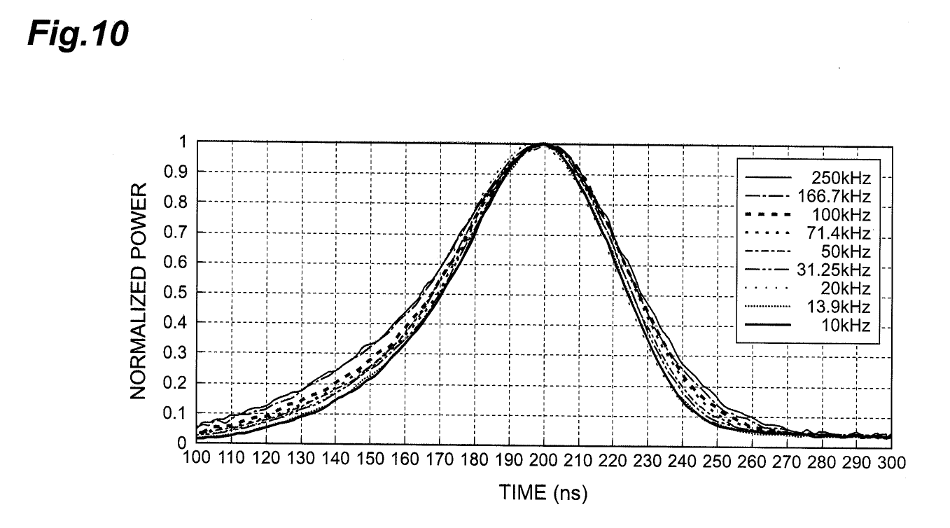

In the following, embodiments of the present invention will be explained in detail with reference to FIGS. 1 to 16. In the description of the drawings, identical or corresponding components are designated by the same reference numerals, and overlapping description is omitted.

### First Embodiment

A first embodiment of a laser according to the present invention will be explained. FIG. 1 is a diagram showing the configuration of a laser 1 of a first embodiment according to the present invention. The laser 1, shown in the diagram, comprises a controller 10, an optical amplification fiber 11, a pumping light source 12, an optical switch 13, a drive circuit 14, a combiner 15, total reflection mirrors 16 and 17, an optical coupler 18, a lens 19, and an optical isolator 20.

The optical amplification fiber 11 is a gain medium comprising an optical fiber, which has had a fluorescent element added to the optical waveguide region, and when pumping light of a wavelength capable of pumping the fluorescent element is supplied, the fluorescent element emits fluorescence. The fluorescent element is ideally a rare earth element, and more ideally a Yb element or a Er element.

The pumping light source 12 continuously outputs pumping light for pumping the fluorescent element that has been added to the optical amplification fiber 11. The pumping light source 12 ideally comprises a laser diode. The combiner 15 inputs the pumping light outputted from the pumping light source 12, and makes the pumping light incident on the optical coupler 18. Further, the combiner 15 transmits the light outputted from the optical coupler 18 and outputs the light to end face 11a of the optical amplification fiber 11. Furthermore, the combiner 15 transmits the fluorescent element-emitted light that has been outputted from end face 11a of the optical amplification fiber 11, and outputs the light to the optical coupler 18.

The optical switch 13 has a first port 13a, a second port 13b, and a third port 13c. The first port 13a is optically connected to total reflection mirror 16, and the second port 13b is optically connected to optical amplification fiber end face 11b. The third port 13c constitutes a non-reflecting terminal face that lacks an optically connected object. The optical switch 13 is driven and operated by the drive circuit 14, and one of a first optical path between the first port 13a and the second port 13b and a second optical path between the second port 13b and the third port 13c selectively constitutes a light-transmissible state.

The optical switch 13 can be a switch that uses an acousto-optic effect, a switch that uses an electro-optic effect, or a piezoelectric type switch. When the optical switch 13 is one that uses an acousto-optic effect, the light outputted from end face 11b of the optical amplification fiber 11 when a high-frequency voltage is not being applied to the optical switch 13 is outputted to total reflection mirror 16 from the first port 13a without being diffracted. Further, when a high-frequency voltage is being applied to the optical switch 13, the light outputted from end face 11b of the optical amplification fiber 11 is diffracted and outputted to the non-reflecting terminal face from the third port 13c

The switching of the optical switch 13 is carried out by the drive circuit 14. For example, a function generator is used as the drive circuit 14.

The optical coupler 18 inputs the light that has arrived from the combiner 15, splits and outputs a portion of the light to the lens 19, and outputs the remainder of the light to total reflection mirror 17. For example, a 6 dB coupler is used as the optical coupler 18.

The lens 19 inputs the light outputted from the optical coupler 18, and outputs the light to the optical isolator 20. Further, the optical isolator 20 inputs the light outputted from the lens 19, and outputs the light to the outside as a pulsed beam to be outputted from the laser 1, but does not allow light to pass through in the opposite direction.

The controller 10 instructs the switching of the optical switch 13 via the drive circuit 14. Further, the controller 10 also controls the extinction ratio for the repetition frequency (the frequency of repeat use) and controls the open time of the optical switch 13.

In the laser 1 configured as described hereinabove, the pumping light continuously outputted from the pumping light source 12 is outputted to the optical coupler 18 by the combiner 15. The light outputted from the optical coupler 18 to total reflection mirror 17 is inputted to the optical coupler 18 once again subsequent to being reflected by total reflection mirror 17, and is outputted to the combiner 15. The light inputted to the combiner 15 passes through the combiner 15 and is inputted to end face 11b of the optical amplification fiber 11, which is the laser medium, and pumps the fluorescent element that has been added to the optical amplification fiber 11. When the first optical path between the first port 13a and second port 13b of the optical switch 13 constitutes the light-transmissible state, the optical system between total reflection mirror 16 and total reflection mirror 17 configures a Fabry-Perot resonator, and the optical amplification fiber 11 is arranged on the resonating optical path of the resonator as the laser medium. Further, when the second optical path between the second port 13b and the third port 13c is in the light-transmissible state, the above-mentioned resonator losses of the resonator reach the maximum, and the light outputted from the optical amplification fiber 11 serving as the laser medium reaches the non-reflecting terminal face. In this way, the optical switch 13 and drive circuit 14 of the present embodiment are used as Q-switching means, making it possible to output a pulsed beam from the resonator.

A specific example of the configuration of the laser 1 according to the first embodiment is as follows. The optical amplification fiber 11 is an optical fiber to which the Yb element has been added to the optical waveguide region, the pumping light source 12 outputs pumping light in the 915 nm wavelength band that is capable of pumping the Yb element, and the optical amplification fiber 11 emits a fluorescence in the 1.06 μm wavelength band at this time. The optical amplification fiber 11 is a double-clad fiber that is 2.7 m long, has a core diameter of 10 μm, and an inner cladding diameter of 125 μm, and features a non-saturated absorption coefficient of 2.8 dB/m relative to the pumping light in the 915 nm wavelength band. The 915 nm wavelength band pumping power supplied to the optical amplification fiber 11 from the pumping light source 12 is 1.4 W, and this power is supplied continuously. The average CW output when the optical switch is open is 0.05 W at this time. The optical switch 13 is an AO switch that uses the acousto-optic effect, and the drive circuit 14 applies an RF voltage to the optical switch 13. The switching repetition frequency of the optical switch 13 is variable. Further, in the specific configuration described above, the distances between the respective components comprising the laser 1 are shortened and arranged such that the distance between total reflection mirror 16 and total reflection mirror 17 is 4.4 m. Therefore, the circulation length in the resonator of the laser 1 is 8.8 m.

A method for suppressing fluctuations in the pulse width of the respective pulses of the pulsed beam outputted from the laser 1 according to the first embodiment will be explained here. To maintain the pulse width of each pulse of the pulsed beam outputted from the laser 1 without relying on the repetition frequency, the inventors discovered that it is important (1) to optimize the extinction ratio corresponding to the repetition frequency, and (2) to optimize the open time of the optical switch. Furthermore, “extinction ratio” denotes the difference between the insertion loss (dB) of the optical switch in the open state, and the insertion loss (dB) of the optical switch in the closed state.

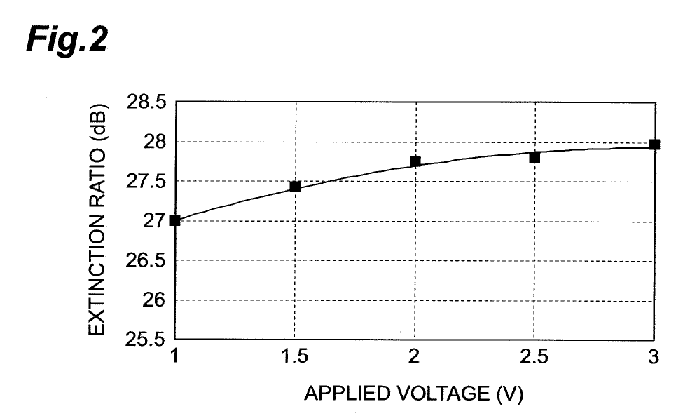

First, the (1) optimization of the extinction ratio corresponding to the repetition frequency will be explained. FIG. 2 is a diagram showing the relationship between the extinction ratio and the voltage applied to the optical switch 13 when the configuration of the laser 1 according to the first embodiment is the configuration example described hereinabove. It is clear that the extinction ratio fluctuates in accordance with changing the voltage applied to the optical switch 13.

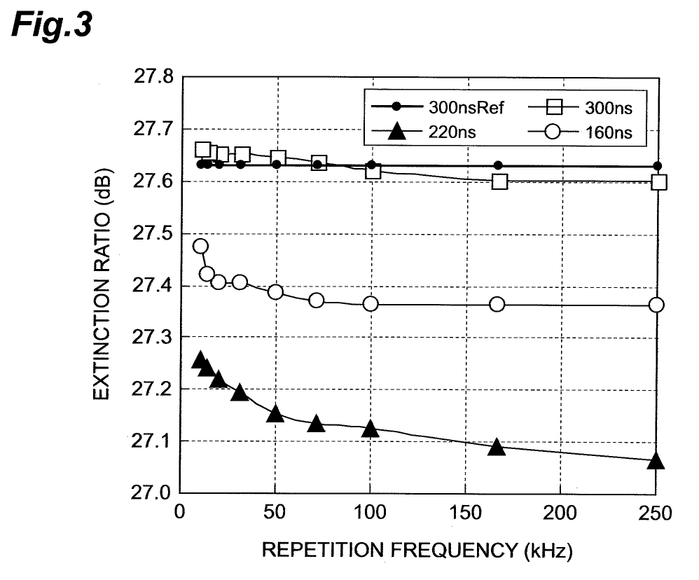

Conversely, when outputting a pulsed beam using the above-described laser 1, an extinction ratio that suppresses fluctuations in the pulse widths of the respective pulses is selected. Since an extinction ratio that suppresses pulse width fluctuations will depend on the length of the optical amplification fiber used in the resonator inside the laser, the fiber design, the pumping power and the output pulse width, it is preferable that the extinction ratio be experientially determined for each laser configuration. FIG. 3 is a diagram showing favorable extinction ratios corresponding to the repetition frequencies (250 kHz, 166.7 kHz, 100 kHz, 71.4 kHz, 50 kHz, 31.25 kHz, 20 kHz, 13.9 kHz and 10 kHz) when using the laser 1 comprising the above-described configuration example. The extinction ratio for favorably suppressing the fluctuations of the pulse widths of each pulse of the pulsed beam fluctuates in accordance with the open time of the optical switch. FIG. 3 shows ideal extinction ratios corresponding to repetition frequencies when the optical switch open time is 160 ns, 220 ns and 300 ns. Because the extinction ratio fluctuates in accordance with an applied voltage as shown in FIG. 2, changing the extinction ratio can be carried out by changing the applied voltage. Furthermore, the 300 ns Ref line in FIG. 3 connects the points constituting an extinction ratio of 27.63 dB for the respective repetition frequencies. This shows the extinction ratios that are used in the measurements described below.

Next, the effect of suppressing pulse fluctuations by optimizing the extinction ratio in the laser 1 according to the first embodiment will be explained by comparing a case in which a pulsed beam is outputted using the ideal extinction ratios corresponding to the repetition frequencies obtained in FIG. 3 against a case in which a pulsed beam is outputted without taking the extinction ratio into consideration.

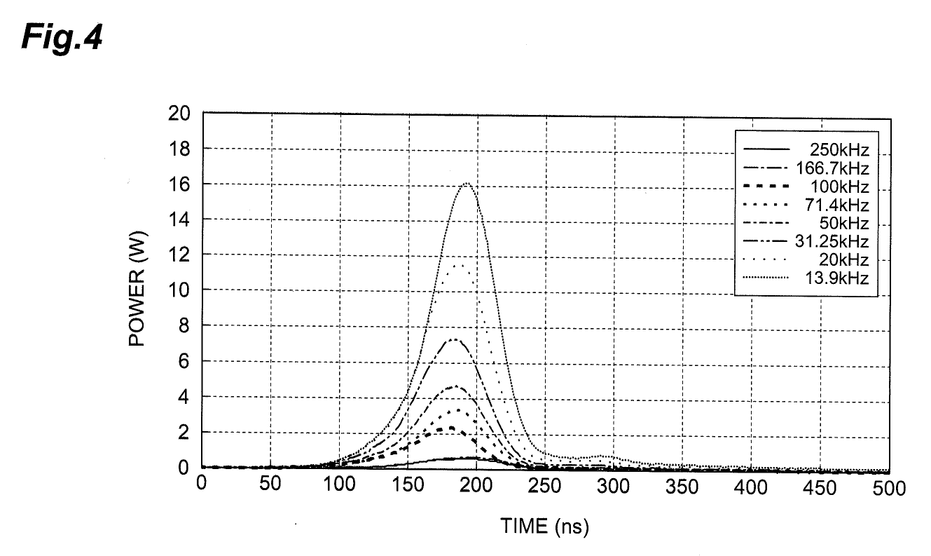

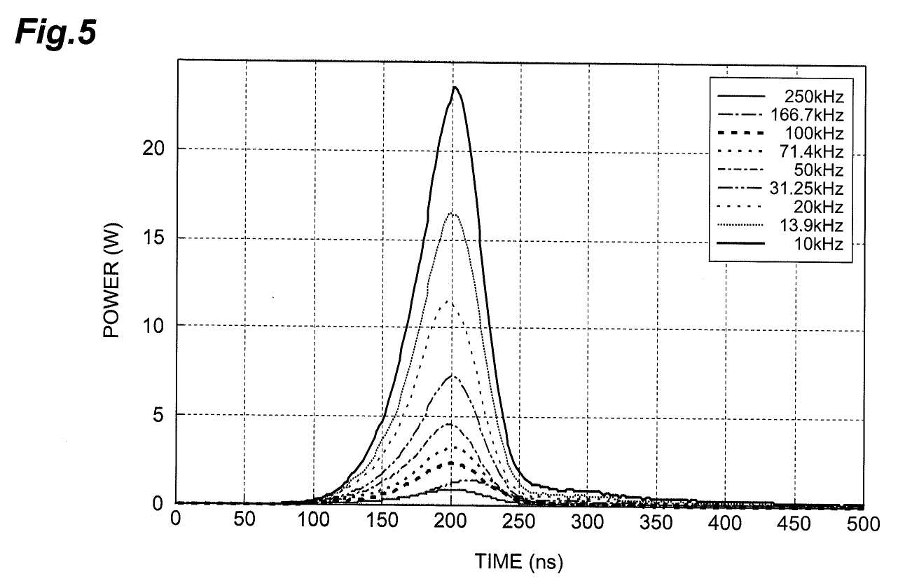

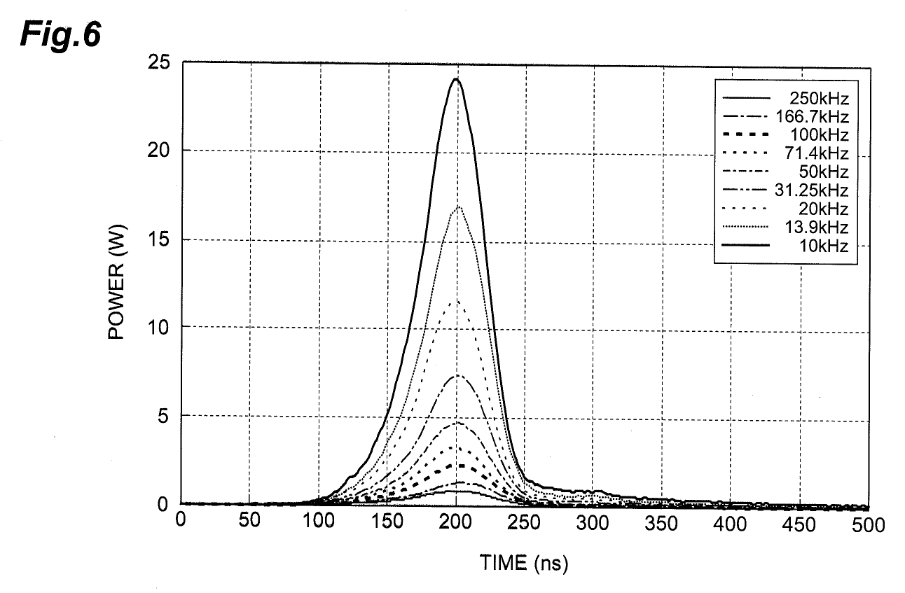

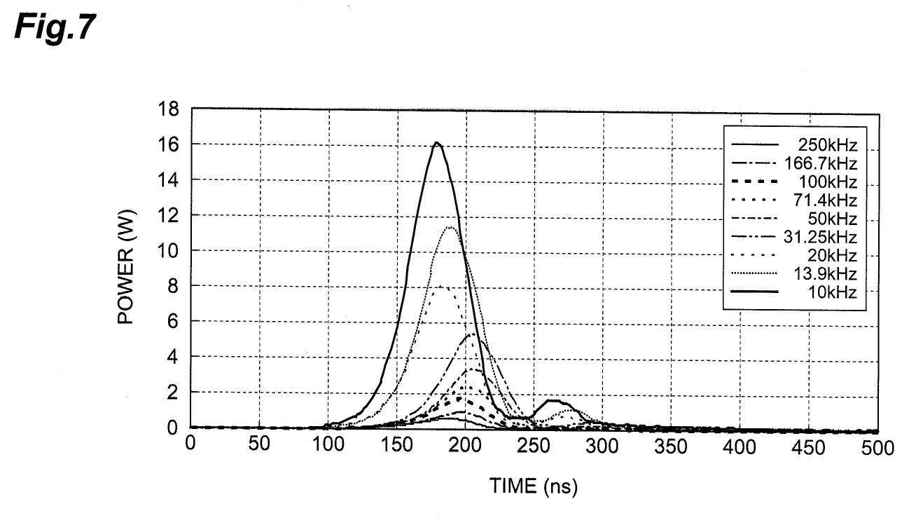

FIGS. 4 to 7 are diagrams showing the pulse shapes of the respective pulses of a pulsed beam. FIG. 4 shows the pulse waveforms of respective pulses when outputting a pulsed beam from the laser by fixing the optical switch open time at 300 ns and the extinction ratio at 27.63 dB, and changing the repetition frequency from 250 kHz to 166.7 kHz, 100 kHz, 71.4 kHz, 50 kHz, 31.25 kHz, 20 kHz, and 13.9 kHz. FIG. 5 shows the pulse waveforms of respective pulses when outputting a pulsed beam from the laser by setting the optical switch open time at 300 ns and selecting the repetition frequency from among 250 kHz, 166.7 kHz, 100 kHz, 71.4 kHz, 50 kHz, 31.25 kHz, 20 kHz, 13.9 kHz and 10 kHz based on the relationships between the extinction ratios and the respective repetition frequencies of FIG. 3. FIG. 6 shows the same output conditions as FIG. 5 with the exception that the optical switch open time has been set to 220 ns, and shows pulse waveforms of respective pulses when outputting a pulsed beam from the laser by selecting the repetition frequency based on the relationships between the extinction ratios and the respective repetition frequencies of FIG. 3. Further, FIG. 7 shows the same output conditions as FIG. 5 with the exception that the optical switch open time has been set to 160 ns, and shows pulse waveforms of respective pulses when outputting a pulsed beam from the laser by selecting the repetition frequency based on the relationships between the extinction ratios and the respective repetition frequencies of FIG. 3.

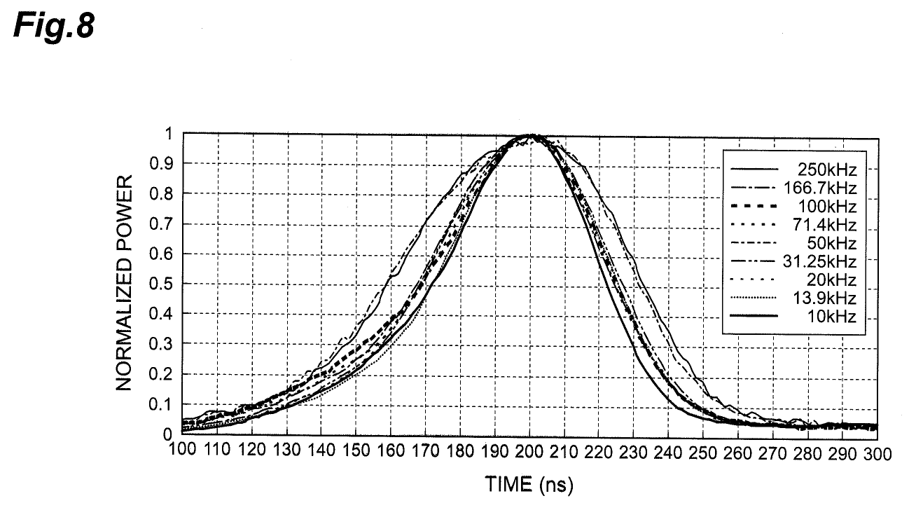

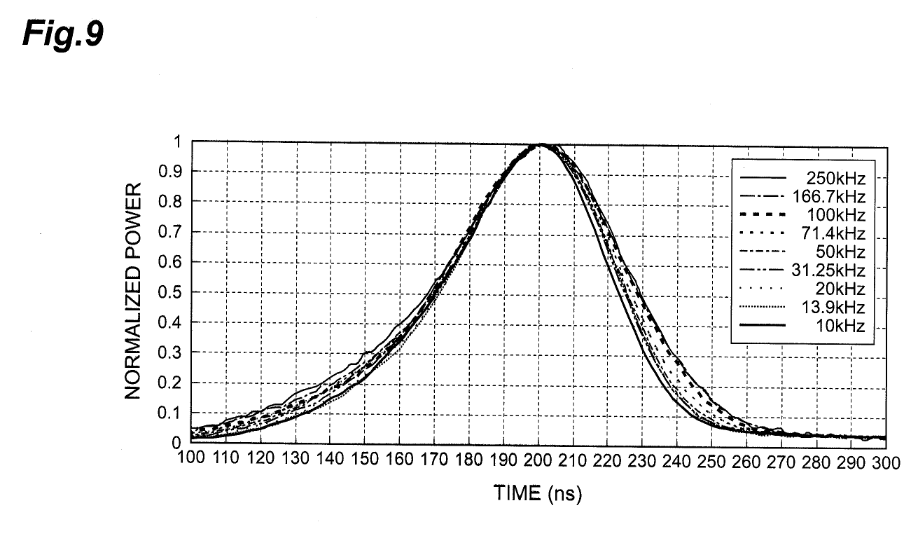

Further, FIGS. 8 to 11 are diagrams in which the pulse waveforms of the respective pulses of the pulsed beams shown in FIGS. 4 to 7 have been normalized. FIG. 8 shows the normalized pulse waveforms of FIG. 4. Further, FIGS. 9, 10 and 11 respectively show the normalized pulse waveforms of FIGS. 5, 6 and 7.

As shown in FIGS. 4 and 8, it was ascertained that when the laser extinction ratio is fixed and the repetition frequency is changed, the full width at half maximum of the pulse widens when the repetition frequency is high. Specifically, it was ascertained that the pulse full width at half maximum increased roughly 50% at repetition frequencies of 166.7 kHz or higher as compared to the pulse full width at half maximum at the repetition frequency of 13.9 kHz. Further, the pulse full width at half maximum also increased 30% at repetition frequencies of 166.7 kHz or higher as compared to the pulse full width at half maximum at the repetition frequency of 20 Hz.

Conversely, when outputting a pulsed beam by optimizing the extinction ratio on the basis of FIG. 3 as a shown in FIGS. 5 to 7, the full width at half maximum fluctuations of the respective pulses is suppressed. The width of the fluctuation was within 10% at repetition frequencies of 100 kHz or less based on the pulse full width at half maximum at a repetition frequency of either 10 kHz or 20 kHz, and was within 20% even at repetition frequencies of 250 kHz or less. It was thus ascertained that pulse width fluctuations are suppressed by optimizing the extinction ratio.

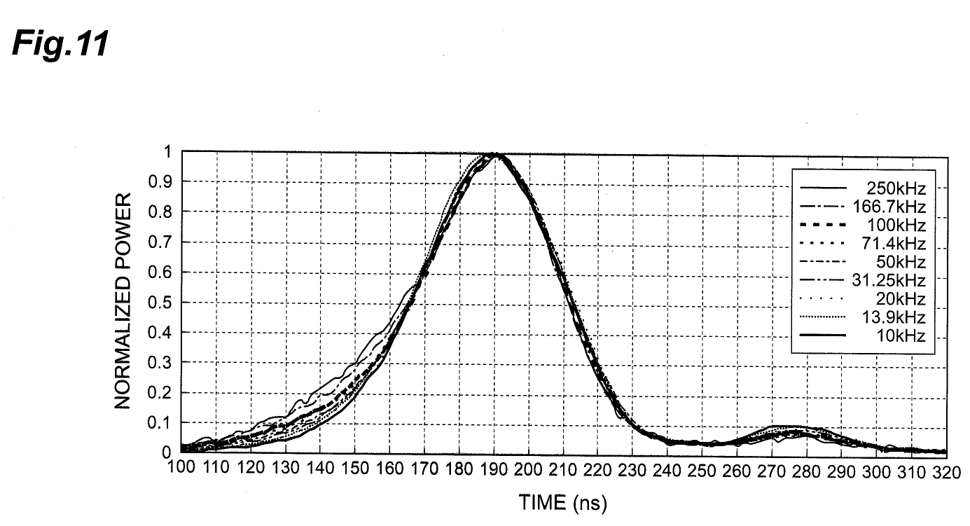

Next, the (2) optimization of optical switch open time will be explained. First, pulse width fluctuation is suppressed by shortening the optical switch open time of the laser. For example, as shown in FIGS. 7 and 11, when the optical switch open time is 160 ns, pulse width fluctuation was held to within 3% at repetition frequencies of 100 kHz or less based on the full width at half maximum at a repetition frequency of 20 kHz, and was within 10% even at repetition frequencies of 250 kHz or less.

However, when the optical switch open time is set a 160 ns, there is a big drop in the pulse peak value, and this becomes a problem in that the size of the pulse peak value becomes around ⅔ compared to that of the pulse waveforms of FIGS. 4 to 6 for which the optical switch open times were long. This is because the energy accumulated inside the resonator cannot be sufficiently emitted as a pulsed beam when the optical switch open time is short. In the configuration example described above, the circulation length of the light inside the resonator is 8.8 m and the time required (circulation time) for the light to go back and forth is approximately 40 ns. Thus, when the circulation time is not lengthened to a certain extent, the energy to be outputted in the respective pulses of the pulsed beam decays, making the drop in the pulse peak value greater.

To favorably suppress fluctuations in pulse width, it is preferable that the optical switch open time of the laser be made around four times shorter than the circulation time of the resonator. However, if the optical switch open time is made shorter than three times the resonator circulation time, the behavior of Q-switching means becomes unstable, thereby giving rise to conditions in which a single pulse is divided into two or more peaks. Conversely, in the configuration example described above, it was ascertained that Q-switching means behavior also became unstable when the optical switch open time was lengthened to 300 ns, which is equivalent to approximately seven times the resonator circulation time.

Thus, the problem is that the pulse peaks of the respective pulses of a pulsed beam can be enlarged by lengthening the optical switch open time, but pulse width fluctuations become greater. With the foregoing in view, it is preferable that the optical switch open time, that is, the open time of Q-switching means be between three and seven times that of the resonator circulation time. It is also preferable that the open time of Q-switching means be between three and four times that of the resonator circulation time when placing priority on the pulse width fluctuation suppression effect. Conversely, when a high pulse peak value is required, as when using the laser in processing for which the peak power of the pulsed beam is vital, such as in a laser marking process, it is preferable that Q-switching means open time be increased to more than four times that of the resonator circulation time.

In the laser 1 according the first embodiment, the above-mentioned optimization of the extinction ratio and optimization of the optical switch 13 open time are carried out by the controller 10. For example, the controller 10 stores beforehand a table of repetition frequencies and ideal extinction ratios corresponding thereto, and a table showing the applied voltages for realizing ideal extinction ratios, and controls the optical switch 13 and drive circuit 14 so as to achieve the appropriate extinction ratio and applied voltage by referring to these tables when driving the optical switch 13, thereby making it possible to suppress the pulse widths of the respective pulses of a pulsed beam. Since a repetition frequency and the ideal extinction ratio corresponding thereto and an applied voltage for realizing the ideal extinction ratio are dependent on the length of the optical amplification fiber used in the resonator inside the laser, fiber design, and pumping power, acquiring data on a laser at the time this laser is initially manufactured and storing this data in advance in the controller will make it possible to output a pulsed beam using an ideal extinction ratio and open time when using the laser.

Thus, in accordance with the laser 1 of the present embodiment, since pulse width fluctuations of the respective pulses can be suppressed even when the repetition frequency of the pulsed beam to be outputted is changed, when this laser is used in laser processing, for example, the affects of heat buildup on the object being processed can be reduced. Further, when using this laser for optical measurement, since it is possible to suppress the deterioration of temporal resolution in accordance with widening the peak widths of the respective pulses, accurate measurements can be carried out.

### Second Embodiment

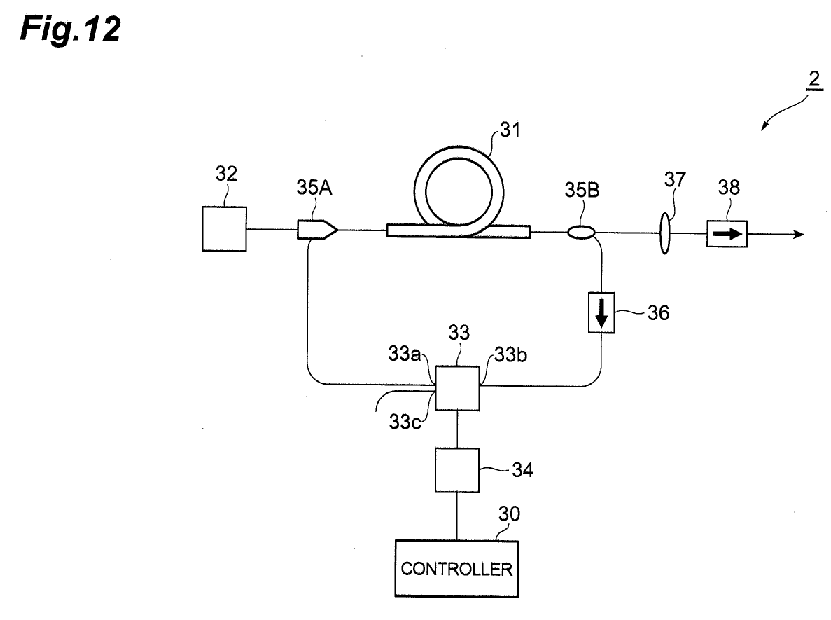

Next, second embodiment according to the present invention will be explained. FIG. 12 is a diagram showing the configuration of a laser 2 according to a second embodiment according to the present invention. The laser 2, shown in the diagram, comprises a controller 30, an optical amplification fiber 31, a pumping light source 32, an optical switch 33, a drive circuit 34, a combiner 35A, an optical coupler 35B, an optical isolator 36, a lens 37, and an optical isolator 38.

The optical amplification fiber 31 is an optical fiber, which has had a fluorescent element added to the optical waveguide region, and when pumping light of a wavelength capable of pumping this fluorescent element is supplied, fluorescence is emitted from this fluorescent element. The fluorescent element is ideally a rare earth element, and more ideally an Er element or a Yb element.

The pumping light source 32 continuously outputs pumping light for pumping the fluorescent element that has been added to the optical amplification fiber 31. The pumping light source 32 ideally comprises a laser diode. The combiner 35A inputs the pumping light outputted from the pumping light source 32, and outputs the pumping light to the optical amplification fiber 31. Further, the combiner 35A inputs light that has arrived from a first port 33a of the optical switch 33, and outputs the light to the optical amplification fiber 31.

The optical switch 33 has a first port 33a, a second port 33b, and a third port 33c. The first port 33a is optically connected to the combiner 35A, the second port 33b is optically connected to optical isolator 36, and the third port 33c is a non-reflecting terminal face. The optical switch 33 is driven and operated by the drive circuit 34, and one of a first optical path between the first port 33a and the second port 33b and a second optical path between the second port 33b and the third port 33c selectively constitutes a light-transmissible state. It is preferable that the optical switch 33 utilize a piezo-optic effect, and can also utilize an acousto-optic effect.

The optical coupler 35B inputs light that has arrived from the optical amplification fiber 31, splits and outputs a portion of the light to the lens 37, and outputs the remainder of the light to optical isolator 36. A 10 dB coupler is used as the optical coupler 35B.

Optical isolator 36 allows light arriving from the optical coupler 35B to pass through to the second port 33b of the optical switch 33, but does not allow light to pass through in the opposite direction.

The lens 37 inputs light outputted from the optical coupler 35B, and outputs the light to optical isolator 38. Further, optical isolator 38 inputs the light outputted from the lens 37, and outputs the light to the outside as a pulsed beam to be outputted from the laser 2, but does not allow light to pass through from the opposite direction.

The controller 10 instructs the switching of the optical switch 33 in accordance with the drive circuit 34. Further, the controller 10 also controls the extinction ratio relative to the repetition frequency, and controls the open time of the optical switch 33.

In the laser 2 that is configured like this, the pumping light, which is continuously outputted from the pumping light source 32, is supplied to the optical amplification fiber 31, which is the laser medium, by way of the combiner 35, and pumps the fluorescent element that has been added to the optical amplification fiber 31. That is, these components are used as pumping means for continuously supplying pumping energy to the optical amplification fiber 31, which is the laser medium.

Further, when the first optical path between the first port 33a and the second port 33b of the optical switch 33 constitutes the light-transmissible state, an optical system comprising the optical amplification fiber 31, optical coupler 35B, optical isolator 36, optical switch 33 and combiner 35A configures a ring-type resonator, and the optical amplification fiber 31 is arranged on the resonating optical path of the resonator as the laser medium. Further, when the second optical path between the second port 33b and the third port 33c of the optical switch 33 constitutes the light-transmissible state, the above-mentioned resonator losses of the resonator are the maximum. Thus, the optical switch 33 and drive circuit 34 are used as Q-switching means for modulating resonator losses of the resonator, making it possible to output a pulsed beam from the resonator.

A specific example of the configuration of the laser 2 according to the second embodiment is as follows. The optical amplification fiber 31 is an optical fiber, which has had a Yb element added to the optical waveguide region, the pumping light source 32 outputs pumping light in the 915 nm wavelength band that is capable of pumping the Yb element, and the optical amplification fiber 31 emits a fluorescence in the 1.06 μm wavelength band at this time. The optical amplification fiber 31 is a double-clad fiber that is 2.7 m long, has a core diameter of 10 μm, and an inner cladding diameter of 125 μm, and features a non-saturated absorption coefficient of 2.8 dB/m relative to the pumping light in the 915 nm wavelength band. The 915 nm wavelength band pumping power supplied to the optical amplification fiber 31 from the pumping light source 32 is 1.8 W, and the power is supplied continuously. The average CW output when the optical switch is open is 0.24 W at this time. The optical switch 33 is an AO switch that uses the acousto-optic effect, and the drive circuit 34 applies an RF voltage to the optical switch 33. The switching repetition frequency of the optical switch 33 is variable. Further, in the specific configuration described above, the distances between the respective parts comprising the laser 2 are shortened and arranged such that the circulation length in the resonator of the laser 2 is 8 m.

In a case in which there is a ring-type resonator as in the laser 2 according to the second embodiment, it is still possible to suppress fluctuations in the pulse width of the respective pulses of a pulsed beam outputted from the laser 2 by optimizing the extinction ratio for each repetition frequency and optimizing the open time of the optical switch the same as in the laser 1 according to the first embodiment. The extinction ratio optimization and optical coupler open time optimization are carried out by controlling the optical switch 33 and drive circuit 34 in accordance with the controller 30 the same as in the laser 1 according to the first embodiment. Further, the optimization of the extinction ratio is carried out by controlling the applied voltage to change the extinction ratio on the basis of the relationship between applied voltages and extinction ratios shown in FIG. 2.

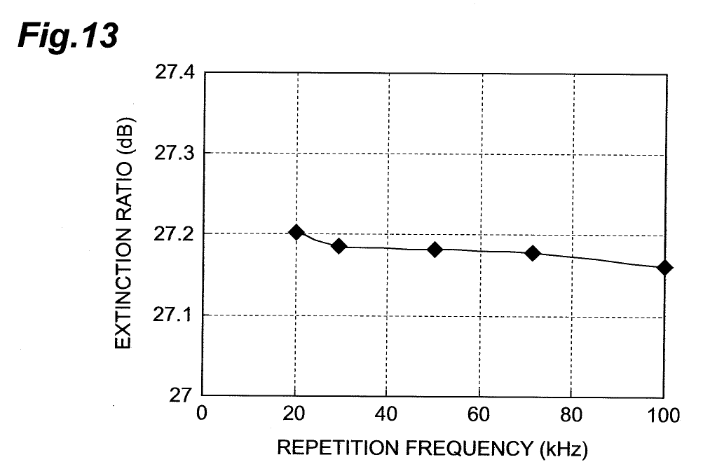

FIG. 13 is a diagram showing the ideal extinction ratios corresponding to the repetition frequencies when using the laser 2 comprising the above-described configuration example. FIG. 13 shows the relationship between the extinction ratio and the repetition frequency when the open time of the optical switch 33 is set at 160 ns, and the ideal extinction ratio changes in accordance with changing the optical switch 33 open time the same as in the relationship (FIG. 3) between ideal extinction ratios and repetition frequencies in the laser 1 of the first embodiment.

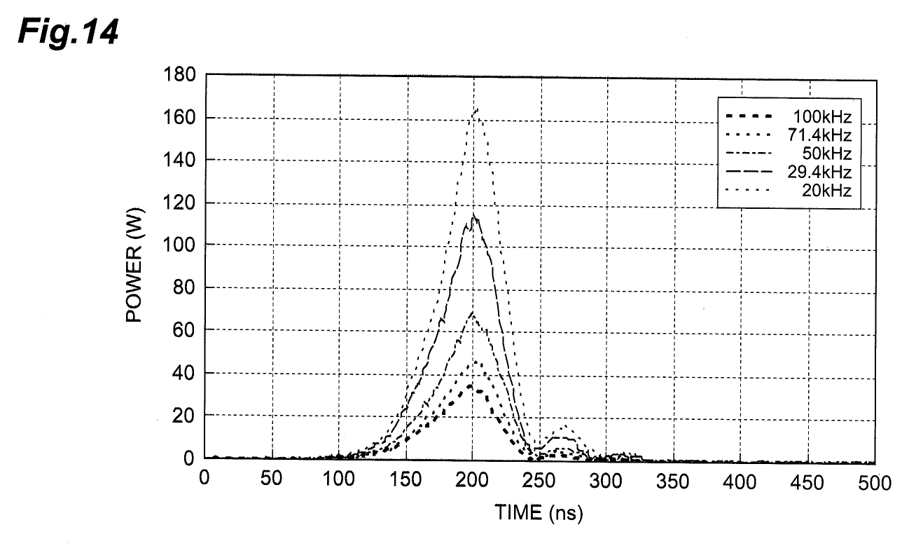

FIG. 14 shows the pulse waveforms of the respective pulses when a pulsed beam is outputted from the laser 2 when the optical switch 33 open time is set at 160 ns, the repetition frequency is respectively set at 100 kHz, 71.4 kHz, 50 kHz, 31.25 kHz and 20 kHz, and the extinction ratio for each repetition frequency is selected on the basis of the relationships of FIG. 13 when using the laser 2 comprising the above-described configuration example.

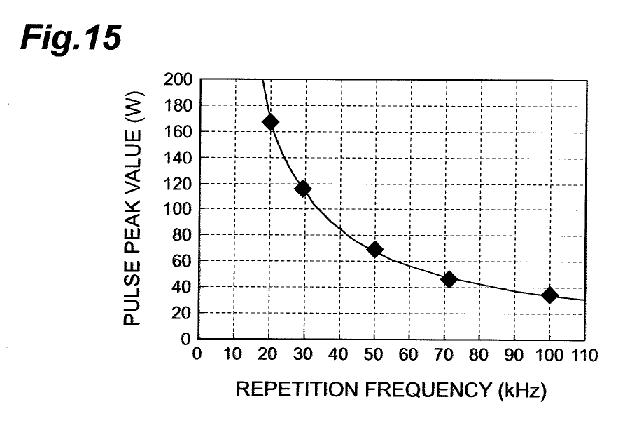

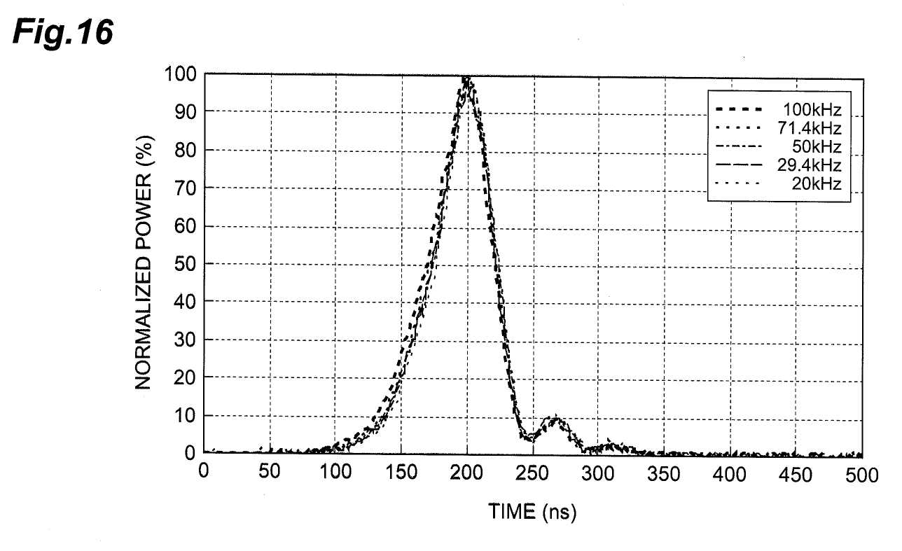

Further, FIG. 15 is a diagram showing the pulse peak values corresponding to repetition frequencies of the pulse waveforms shown in FIG. 14. FIG. 16 is a diagram in which the pulse waveforms shown in FIG. 14 have been normalized.

As shown in FIGS. 14 and 16, when a pulsed beam is outputted by optimizing the extinction ratio on the basis of FIG. 13, full width at half maximum fluctuations of the pulses are suppressed. Further, as shown in FIG. 16, in a measurement that utilizes the laser 2 according to the second embodiment, not only do the full widths at half maximum of the pulses substantially match up, but the parts from the rising edge to the falling edge of the pulse waveforms also substantially match up. Thus, pulse width fluctuations are effectively suppressed by optimizing the extinction ratio.

Furthermore, the pulse peak value of the pulsed beam can also be ideally set for the pulsed beam irradiation target by controlling the open time of the optical switch 33 in the laser 2 according to the second embodiment as well.

(Laser Processing)

When carrying out laser processing, it is necessary to optimize the pulse energy of the pulsed beam in accordance with the material and shape of the object to be processed. When carrying out laser processing using the lasers according to the above-described first and second embodiments, the pulse peak values and pulse energy of the respective pulses of the pulsed beam can be controlled by changing the repetition frequency. Furthermore, when the repetition frequency is high, there is the likelihood that the affect of heat buildup in the irradiation location will increase when pulsed beams are irradiated numerous times onto the same spot of the object being processed. Therefore, it is preferable to use a laser processing apparatus in which the rate of movement of the object being processed varies relative to the pulsed beam irradiation location, and to change the rate of movement in accordance with the repetition frequency.

In accordance with the present invention, there is provided a laser in which pulse width fluctuations are suppressed, a laser oscillation method, and a laser processing method and laser measurement method that make use of this laser.

What is claimed is:

1. A laser oscillation method of oscillating a pulsed beam using a laser having pumping means, a resonator, Q-switching means and a controller, the laser oscillation method comprising the steps of:
continuously supplying pumping light by the pumping means to a gain medium, which is arranged on a resonating optical path of the resonator and generates emission light by being supplied with pumping energy;
modulating resonator losses of the resonator by the Q-switching means; and
controlling by the controller an extinction ratio of the Q-switching means to a value that has been selected in accordance with a repetition frequency such that full width at half maximum fluctuations of respective pulses of a pulsed beam outputted from the laser are within a prescribed range of a repetition frequency region used by the Q-switching means.

2. A laser oscillation method according to claim 1, wherein the controller sets open time of the Q-switching means to between three and seven times circulation time during which the emission light to be emitted by the gain medium circulates in the resonator.

3. A laser oscillation method according to claim 1, wherein the controller sets open time of the Q-switching means to between three and four times circulation time during which the emission light to be emitted by the gain medium circulates in the resonator.

4. A laser oscillation method according to claim 1, wherein the controller sets open time of the Q-switching means to between four and seven times circulation time during which the emission light to be emitted by the gain medium circulates in the resonator.

5. A laser oscillation method according to claim 1, wherein the controller controls the Q-switching means such that a region of frequency of repeat use comprises a range from 10 to 100 kHz, and the full width at half maximum of respective pulses of the pulsed beam within this range is within ±10% when the region of frequency of repeat use of 20 kHz is used as a reference.

6. A laser oscillation method according to claim 1, wherein the controller controls the Q-switching means such that a region of frequency of repeat use comprises a range from 20 to 250 kHz, and the full width at half maximum of respective pulses of the pulsed beam within this range is within ±20% when the region of frequency of repeat use of 20 kHz is used as a reference.

7. A laser for oscillating a pulsed beam, comprising:
a resonator, for which a gain medium for generating emission light by being supplied with pumping energy is arranged on a resonating optical path;
pumping means for continuously supplying pumping energy to the gain medium;
Q-switching means for modulating resonator losses of the resonator; and
a controller for controlling an extinction ratio of the Q-switching means to a value that has been selected in accordance with a repetition frequency such that full width at half maximum fluctuations of the respective pulses of a pulsed beam outputted from the laser fall within a prescribed range in the region of frequency of repeat use used by the Q-switching means.

8. A laser according to claim 7, wherein the controller sets open time of the Q-switching means to between three and seven times circulation time during which emission light to be emitted by the gain medium circulates in the resonator.

9. A laser according to claim 7, wherein the controller sets open time of the Q-switching means to between three and four times circulation time during which emission light to be emitted by the gain medium circulates in the resonator.

10. A laser according to claim 7, wherein the region of frequency of repeat use comprises a range of 10 to 100 kHz.

11. A laser processing method comprising a step of processing an object to be processed by irradiating a pulsed beam oscillated from a laser according to claim 7 onto the object to be processed.

12. A laser processing method according to claim 11, further comprising a step of controlling a rate of movement of the object to be processed relative to an irradiation location of a pulsed beam oscillated from the laser to a predetermined percentage of overlap of beam spots where the pulsed beam oscillated from the laser is irradiated at each pulse.

13. A laser processing method for processing an object to be processed by irradiating a pulsed beam oscillated from a laser according to claim 8 onto the object to be processed, comprising the step of optimizing a pulse peak of the pulsed beam by controlling open time of the Q-switching means by the controller.

14. A laser measurement method further comprising a step of irradiating a pulsed beam oscillated from the laser according to claim 7 onto an object to be measured, and measuring a physical quantity of the object to be measured by measuring a reflected light that is reflected by the surface of the object to be measured.
